(19) United States
(12) Patent Application Publication
(10) Pub. No.: US 2016/0325414 A1
(43) Pub. Date: Nov. 10, 2016

(54) METHOD FOR MEASURING INERTIA MOMENT OF IMPACT ROTARY TOOL AND IMPACT ROTARY TOOL USING MEASURING METHOD

(71) Applicant: PANASONIC INTELLECTUAL PROPERTY MANAGEMENT CO., LTD., Osaka-shi (JP)

(72) Inventors: Mitsumasa MIZUNO, Osaka (JP); Fumiaki SEKINO, Osaka (JP); Ryuji OTANI, Osaka (JP)

(21) Appl. No.: 15/109,047

(22) PCT Filed: Dec. 10, 2014
(86) PCT No.: PCT/JP2014/006161

§ 371 Date: Jun. 29, 2016

(30) Foreign Application Priority Data
Jan. 6, 2014 (JP) 2014-000539

(51) Int. Cl. B25B 23/147; B25B 23/145; B25B 21/02

(52) U.S. Cl. CPC B25B 23/1475; B25B 21/02; B25B 23/1453

(57) ABSTRACT

An impact rotation tool includes an impact force generator that changes power of a drive source into pulsed torque to generate impact force. An output shaft transmits the pulsed torque to a bit based on the impact force. A torque measurement unit measures a shaft torque applied to the output shaft. An angular acceleration measurement unit measures angular acceleration of the output shaft. A moment of inertia calculator calculates moment of inertia of the bit coupled to the output shaft when rotated by the output shaft based on the shaft torque and the angular acceleration. A torque calculator calculates tightening torque based on the angular acceleration, the shaft torque, and the moment of inertia. A controller controls the drive source based on the tightening torque.

### TECHNICAL FIELD

The present invention relates to a method for measuring moment of inertia of an impact rotation tool and an impact rotation tool using the measuring method.

### BACKGROUND ART

An impact rotation tool uses hammer impacts or hydraulic pressure to convert rotation output from a motor, which is one example of a drive source, and reduced in speed by a reduction drive into pulsed impact torque to perform tightening and loosening tasks with impact torque. The impact rotation tool obtains higher torque than a rotation tool that uses only a reduction drive and thus increases the working efficiency. Accordingly, the impact rotation tool is widely used in construction sites and assembly plants (see, for example, Patent Document 1).

### PRIOR ART DOCUMENT

### Patent Document

Patent Document 1: Japanese Laid-Open Patent Publication No. 2012-206181

### SUMMARY OF THE INVENTION

### Problems that are to be Solved by the Invention

In the impact rotation tool, high torque may over-tighten a subject. When a subject such as a bolt or a screw is loosely tightened to avoid such over-tightening, the subject may not be tightened with the desired strength.

To tighten a subject with a predetermined torque, a sensor such as a torque sensor arranged on the output shaft may be used to measure the torque and stop driving the motor when the torque, which corresponds to the output value of the sensor, reaches the predetermined torque such as the target torque. In such a case, the moment of inertia needs to be corrected. However, the moment of inertia may change in accordance with the member coupled to the output shaft.

It is an object of the present invention to provide a method for measuring moment of inertia of an impact rotation tool and an impact rotation tool using the measuring method that allow for correct measurement of the moment of inertia.

### Means for Solving the Problem

A method for measuring moment of inertia of an impact rotation tool according to one embodiment of the present invention includes measuring a shaft torque applied to an output shaft driven by a drive source with a torque measurement unit, measuring angular acceleration of the output shaft with an angular acceleration measurement unit, and calculating moment of inertia of a measured subject that is coupled to the output shaft when rotated by the output shaft based on the shaft torque measured by the torque measurement unit and the angular acceleration measured by the angular acceleration measurement unit.

An impact rotation tool according to one embodiment of the present invention includes a drive source, an impact force generator that changes power of the drive source into pulsed torque to generate impact force, an output shaft that transmits the pulsed torque to a bit based on the impact force, a torque measurement unit that measures a shaft torque applied to the output shaft, an angular acceleration measurement unit that measures angular acceleration of the output shaft, a moment of inertia calculator that calculates moment of inertia of the bit coupled to the output shaft when rotated by the output shaft based on the shaft torque measured by the torque measurement unit and the angular acceleration measured by the angular acceleration measurement unit, a torque calculator that calculates tightening torque based on the angular acceleration, the shaft torque, and the moment of inertia, and a controller that controls the drive source based on the tightening torque.

In one embodiment, the drive source is an electric motor. In this case, the torque measurement unit may measure the shaft torque from a measured value of current supplied to the drive source.

In one embodiment, the drive source is an electric motor. In this case, the angular acceleration unit may measure angular acceleration of the output shaft from speed of the drive source.

In one embodiment, the impact rotation tool further includes an operation unit that is operable to drive the drive source. The bit, which is a measured subject, may be solely coupled to the output shaft. The moment of inertia calculator may calculate the moment of inertia based on the shaft torque and the angular acceleration when a user operates the operation unit to rotate the output shaft.

In one embodiment, the impact rotation tool further includes an operation unit that is operable to drive the drive source. The bit, which is a measured subject, may be solely coupled to the output shaft. The moment of inertia calculator may calculate the moment of inertia based on the shaft torque and the angular acceleration when a user operates the operation unit to rotate the output shaft and based on the shaft torque and the angular acceleration when the output shaft stops.

In one embodiment, the impact rotation tool further includes an operation unit that is operable to drive the drive source. The bit, which is a measured subject, may be solely coupled to the output shaft. The moment of inertia calculator may calculate the moment of inertia based on the shaft torque and the angular acceleration when a user operates the operation unit to accelerate or decelerate the output shaft a number of times.

In one embodiment, the impact rotation tool further includes an operation unit that is operable to drive the drive source. The bit, which is a measured subject, may be solely coupled to the output shaft. The moment of inertia calculator may calculate the moment of inertia based on the shaft torque and the angular acceleration when a user operates the operation unit to accelerate and decelerate the output shaft a number of times.

In one embodiment, the bit, to which a fastener is attached, is coupled to the output shaft. The impact rotation tool is adapted to perform a task for tightening the fastener to a tightened subject. The moment of inertia calculator may calculate the moment of inertia based on the shaft torque and the angular acceleration from when the task for tightening is started to when the fastener is mounted on the tightened subject.

One embodiment may further include a notification unit that issues a notification of completion of calculation of the moment of inertia of the bit coupled to the output shaft.

### Effect of the Invention

The present invention correctly measures moment of inertia of an impact rotation tool.

### BRIEF DESCRIPTION OF THE DRAWINGS

FIG. 1 is a schematic cross-sectional view showing an embodiment of an impact rotation tool.

FIG. 2 is a block diagram showing the electrical configuration of the impact rotation tool.

FIG. 3A is a graph showing changes in rotation angle when the impact rotation tool rotates in a single direction.

FIG. 3B is a graph showing changes in angle speed when the impact rotation tool rotates in a single direction.

FIG. 4 is a flowchart illustrating calculation of moment of inertia of the impact rotation tool.

FIG. 5 is a flowchart showing an example of the operation of the impact rotation tool.

FIG. 6A is a graph showing the shaft torque sensor output.

FIG. 6B is a graph showing the pulse signal of a rotation encoder.

FIG. 6C is a graph showing changes in angle when a shaft rotates.

FIG. 7 is a graph showing the waveform of a voltage signal that is output from a torque calculator.

### EMBODIMENTS OF THE INVENTION

One embodiment of an impact rotation tool will now be described with reference to the drawings.

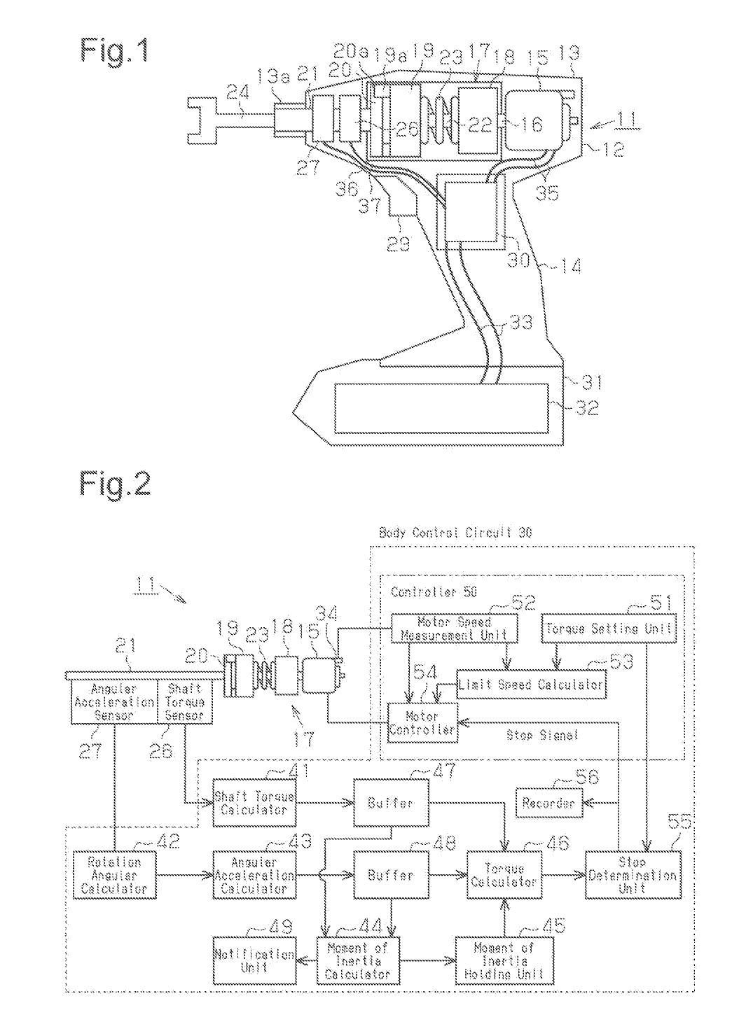

As shown in FIG. 1, an impact rotation tool 11 is a portable handheld tool that can be used as, for example, an impact driver or an impact wrench. A body housing 12 that forms the shell of the impact rotation tool 11 includes a tubular barrel 13, which has a closed end, and a handle 14, which extends from the barrel. The handle 14 extends from the barrel 13 in a direction intersecting the axis of the barrel 13, that is, the downward direction in FIG. 1.

A motor 15, which is one example of a drive source, is allocated in a basal side of the barrel 13, that is, the right side as viewed in FIG. 1. The motor 15 is arranged in the barrel 13 so that the rotation axis of the motor 15 coincides with the axis of the barrel 13 and so that a shaft 16 of the motor 15 is directed toward a distal end of the barrel 13. The motor 15 is, for example, a DC motor such as a brush motor or a brushless motor. An impact force generator 17 is connected to the shaft 16 of the motor 15. The impact force generator 17 converts rotation power of the motor 15 into pulsed torque to generate impact force.

The impact force generator 17 includes a reduction drive 18, a hammer 19, an anvil 20, and a main shaft 21, which is one example of an output shaft, sequentially from the side of the motor 15.

The reduction drive 18 reduces the rotation speed of the motor 15 at a predetermined reduction ratio to obtain the necessary torque. The force of rotation that is reduced in speed and increased in torque by the reduction drive 18 is transmitted to the hammer 19. The hammer 19 strikes the anvil 20. The striking of the hammer 19 applies the rotation force to the main shaft 21 in impulses. The main shaft 21 may be formed integrally with the anvil 20 as part of the anvil 20. Alternatively, the main shaft 21 may be formed separately from the anvil 20 and be fixed to the anvil 20.

The hammer 19 is coupled to a drive shaft 22, which is rotated by the output of the reduction drive 18. The hammer 19 is rotatable relative to the drive shaft 22 and movable along the drive shaft 22 toward the front and rear. Further, the hammer 19 is biased toward the distal side of the barrel 13, which is the left side as viewed in FIG. 1, by the elastic force of a coil spring 23 located between the reduction drive 18 and the hammer 19. The hammer 19 is located at a position where the hammer 19 abuts against the anvil 20.

Two abutment portions 19a, which extend toward the anvil 20, are located at equal intervals in the circumferential direction. The abutment portions 19a abut against abutment portions 20a, which extend in the radial direction of the anvil 20, in the circumferential direction. The rotation of the drive shaft 22, reduced in speed by the reduction drive 18, integrally rotates the abutment portions 19a and 20a, which are abut against one another. This transmits the rotation of the drive shaft 22 to the main shaft 21, which is coaxial with the anvil 20. A chuck 13a is arranged at the distal end, that is, the left end as viewed in FIG. 1, of the barrel 13. The chuck 13a includes a socket hole that allows a bit 24 to be attached to the chuck 13a in a removable manner.

As the bit 24 rotates and a task advances for tightening a fastener such as a bolt or a screw, the load applied to the main shaft 21 becomes larger than when, for example, the tightening of the fastener started. In contrast, as the bit 24 rotates and a task advances for loosening a fastener such as a bolt or a screw, the load applied to the main shaft 21 becomes smaller than when, for example, the loosening of the fastener started. When the force applied between the hammer 19 and the anvil 20 is larger than or equal to a predetermined value, the hammer 19 compresses the coil spring 23 and moves to the rear, which is the right side as viewed in FIG. 1, along the drive shaft 22. When such movement separates the hammer 19 from the anvil 20, the hammer 19 rotates relative to the anvil 20. When the hammer 19 is rotated relative to the anvil 20 by a certain angle or more, the compression force of the coil spring 23 is released so that the biasing force of the coil spring 23 moves the hammer 19 toward the anvil 20 while rotating and strikes the anvil 20. The striking of the hammer 19 is repeated by the load received by the main shaft 21 whenever the hammer 19 rotates relative to the anvil 20 by a certain angle or more. Such striking of the anvil 20 by the hammer 19 acts as an impact on the fastener.

As shown in FIG. 1, a shaft torque sensor 26 and an angular acceleration sensor 27 are coupled to the main shaft 21 of the impact rotation tool 11.

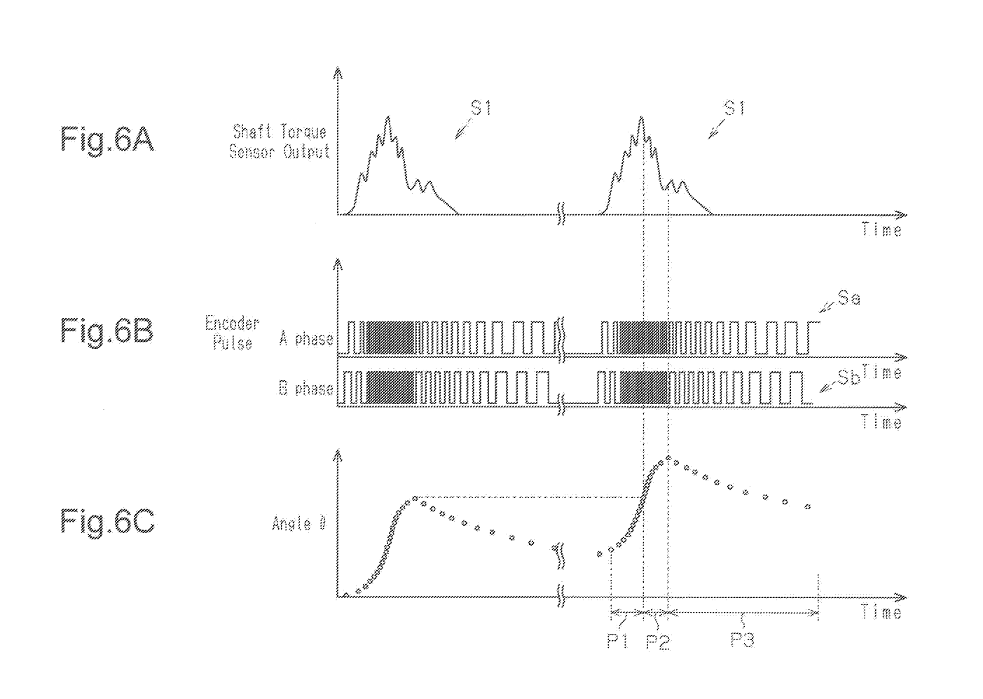

The shaft torque sensor 26 is, for example, a magnetostrictive distortion sensor capable of detecting twist distortion. The shaft torque sensor 26 uses a coil arranged on a non-rotating portion to detect changes in magnetic permeability that correspond to the distortion of the main shaft 21 that occurs when torque is applied to the main shaft 21. Then, the shaft torque sensor 26 outputs a voltage signal that is in proportion to the distortion. The voltage signal that is output by the shaft torque sensor 26 is a torque detection signal S1 (refer to FIG. 6A) corresponding to the torque. The torque detection signal S1 is output from the shaft torque sensor 26 to a shaft torque calculator 41 of a body control circuit 30.

In the present embodiment, the angular acceleration sensor 27 is a rotation encoder. The angular acceleration sensor 27 outputs a two-phase pulse in correspondence with the rotation of the main shaft 21, and a rotation angular calculator 42 converts the two-phase pulse into a rotation angle (angular change amount).

A trigger lever 29, which serves as an operation unit, is arranged on the handle 14. When the trigger lever 29 is operated by a user, the impact rotation tool 11 is driven. A battery pack seat 31, which is formed by a box-shaped accommodation case, is attached in a removable manner to the lower end of the handle 14. A battery pack 32, which is a rechargeable battery, is accommodated in the battery pack seat 31. The impact rotation tool 11 is rechargeable and uses the battery pack 32 as a drive power source. The battery pack 32 is connected to the body control circuit 30 by power wires 33.

The motor 15 includes a speed detector 34 that detects the rotation speed of the motor 15. The speed detector 34 is embodied in a frequency generator that generates a frequency signal having a frequency that is in proportion to the rotation speed of the motor 15. The speed detector 34 may be, for example, a rotation encoder. When the motor 15 is a brushless motor, the speed detector 34 may be a hall sensor capable of detecting the rotation speed from a signal of the hall sensor or from the counter electromotive force. The speed detector 34 sends a signal corresponding to the rotation speed to the body control circuit 30.

The body control circuit 30 is electrically connected to the motor 15 by lead wires 35 to control the driving of the motor 15. A trigger switch that detects operation of the trigger lever 29 is electrically connected to the body control circuit 30.

When the user operates the trigger lever 29, the body control circuit 30 executes control to, for example, change the rotation speed of the motor 15 in accordance with the amount the trigger lever 29 is pulled. The body control circuit 30 controls the current supplied to the motor 15 with a motor driver to control the rotation of the motor 15 and to set the torque. Further, the body control circuit 30 outputs a stop signal or the like when a tightening torque, which is calculated using the output of the shaft torque sensor 26 and the output of the angular acceleration sensor 27, exceeds a target torque.

The body control circuit 30 is electrically connected to the motor 15 by the lead wires 35 to control the driving of the motor 15. Further, signal wires 36 and 37 are connected to the body control circuit 30 to receive signals from the shaft torque sensor 26 and the angular acceleration sensor 27 to the body control circuit 30.

The electric configuration of the impact rotation tool 11 will now be described with reference to FIG. 2.

As shown in FIG. 2, the impact rotation tool 11 includes the shaft torque sensor 26, the angular acceleration sensor 27, and the body control circuit 30.

The body control circuit 30 includes the shaft torque calculator 41 and the rotation angular calculator 42. The shaft torque calculator 41 calculates the torque (shaft torque) applied to the main shaft 21 based on a signal that is output from the shaft torque sensor 26. The rotation angular calculator 42 calculates a rotation angle based on a signal received from the angular acceleration sensor 27. Further, the body control circuit 30 includes an angular acceleration calculator 43 that calculates an angular acceleration based on the rotation angle calculated by the rotation angular calculator 42. In the present embodiment, the shaft torque sensor 26 and the shaft torque calculator 41 form a torque measurement unit, and the angular acceleration sensor 27, the rotation angular calculator 42, and the angular acceleration calculator 43 form an angular acceleration measurement unit.

In addition, the body control circuit 30 includes a moment of inertia calculator 44 that calculates moment of inertia about the rotation shaft (main shaft 21) of the bit 24 based on the shaft torque calculated by the shaft torque calculator 41 and the angular acceleration calculated by the angular acceleration calculator 43. Further, the body control circuit 30 includes a moment of inertia holding unit 45 and a torque calculator 46. The moment of inertia holding unit 45 holds (stores) the moment of inertia calculated by the moment of inertia calculator 44. The torque calculator 46 calculates a tightening torque T based on the shaft torque, the angular acceleration, and the moment of inertia.

In the body control circuit 30 of the present embodiment, the shaft torque calculated by the shaft torque calculator 41 is stored in a buffer 47, and the angular acceleration calculated by the angular acceleration calculator 43 is stored in a buffer 48.

Further, the body control circuit 30 includes a controller 50 that performs, for example, torque management and speed control of the motor 15. The controller 50 includes a torque setting unit 51 that sets a target torque To, which is the target value of the tightening torque T.

The torque setting unit 51 includes, for example, a torque setting operation unit (for example, volume adjustment knob) that is operable by the user. The torque setting unit 51 is electrically connected to a limit speed calculator 53 and a stop determination unit 55. The torque setting unit 51 sets, for example, the target torque To, at which the driven motor 15 is stopped, based on the set torque that is set by the user operating the torque setting operation unit. The torque setting unit 51 sets the target torque To to, for example, a value in the range of ±10% of the set torque. The torque setting unit 51 may set the set torque as the target torque To.

The controller 50 includes a motor speed measurement unit 52 that measures the rotation speed of the motor 15, the limit speed calculator 53 that calculates a limit speed, and a motor controller 54 that controls the driving of the motor 15. The body control circuit 30 includes a CPU, and each of the units 52 to 54 is realized by, for example, a control program (software) executed by the CPU. Alternatively, each of the units 52 to 54 may be hardware formed by an integrated circuit such as an ASIC. As another option, some of the units 52 to 54 may be formed by software, and the remaining units 52 to 54 may be formed by hardware.

The motor speed measurement unit 52 measures the rotation speed of the motor 15 based on a signal corresponding to the speed received from the speed detector 34. The limit speed calculator 53 receives the measured rotation speed of the motor 15 and the target torque To, which has been set in advance, to calculate the limit speed of the rotation speed of the motor 15 when the trigger lever 29 is pulled in accordance with the value of the target torque To. The motor controller 54 controls the driving of the motor 15 to limit the rotation speed of the motor 15 to less than or equal to the limit speed. For example, when the target torque To is small, the motor controller 54 limits the speed of the motor 15 so that the maximum speed is not reached even if the trigger lever 29 is pulled to the maximum.

The body control circuit 30 includes the stop determination unit 55 that determines whether or not the torque value (tightening torque T) calculated by the torque calculator 46 has reached the target torque To. Further, the body control circuit 30 includes a recorder 56 that records the torque value when stopped.

Moment of Inertia Setting Mode

The impact rotation tool 11 of the present embodiment includes a moment of inertia setting mode that sets a moment of inertia. In the moment of inertia setting mode, the body control circuit 30 calculates and sets the moment of inertia I with the main shaft 21, which serves as an output shaft, coupled to the bit 24 before the user performs an actual task. The bit 24 corresponds to a measured subject of the moment of inertia I. The moment of inertia setting mode can be selected when, for example, the user presses a mode selection button (not shown) on the impact rotation tool 11 at an arbitrary timing.

Further, in the moment of inertia setting mode of the impact rotation tool 11 of the present embodiment, the body control circuit 30 sets the moment of inertia I in a series of operations in which the user first pulls the trigger lever 29 and then releases the trigger lever 29.

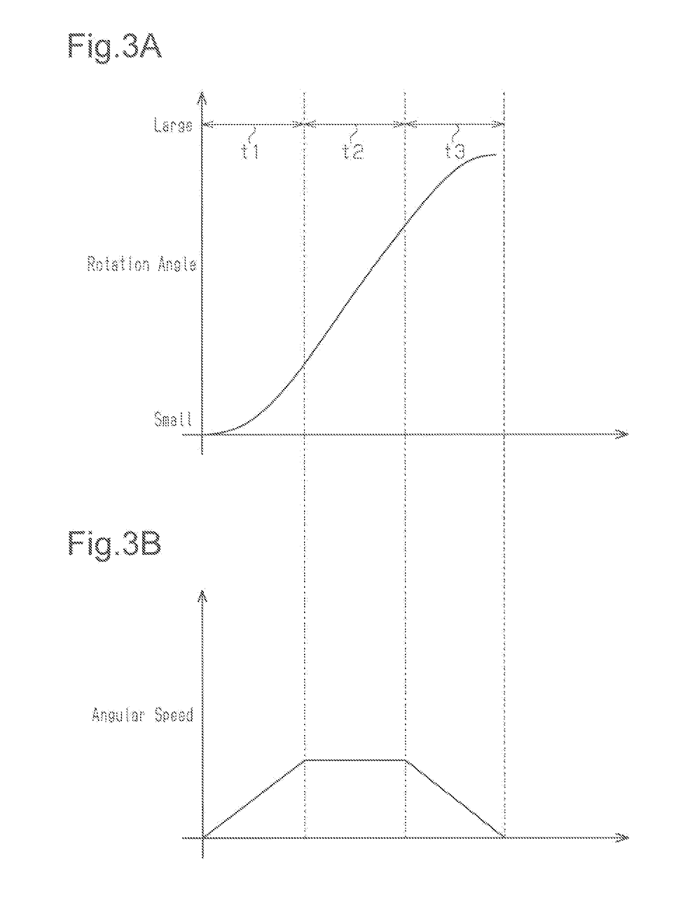

As shown in FIG. 3A, when the trigger lever 29 is pulled to rotate the main shaft 21, the rotation speed increases during predetermined period t1 so as to plot a downwardly-convex quadratic curve (parabola). During predetermined period t1, the angular speed increases (accelerates) as shown in FIG. 3B.

Subsequently, as shown in FIG. 3A, when the trigger lever 29 remains pulled, the main shaft 21 rotates by the constant rotation angle during period t2. During period t2, the angular speed remains unchanged, that is, constant as shown in FIG. 3B.

When the trigger lever 29 is released, the rotation of the main shaft slows, and the rotation angle gradually increases during predetermined period t3 so as to plot an upwardly-convex quadratic curve (parabola). During predetermined period t3, the angular speed decreases (decelerates) as shown in FIG. 3B.

As described above, in the moment of inertia setting mode of the present embodiment, when the main shaft 21 rotates in a single direction and the speed changes, the body control circuit 30 calculates the moment of inertia during acceleration (predetermined period t1) and the moment of inertia during deceleration (predetermined period t3).

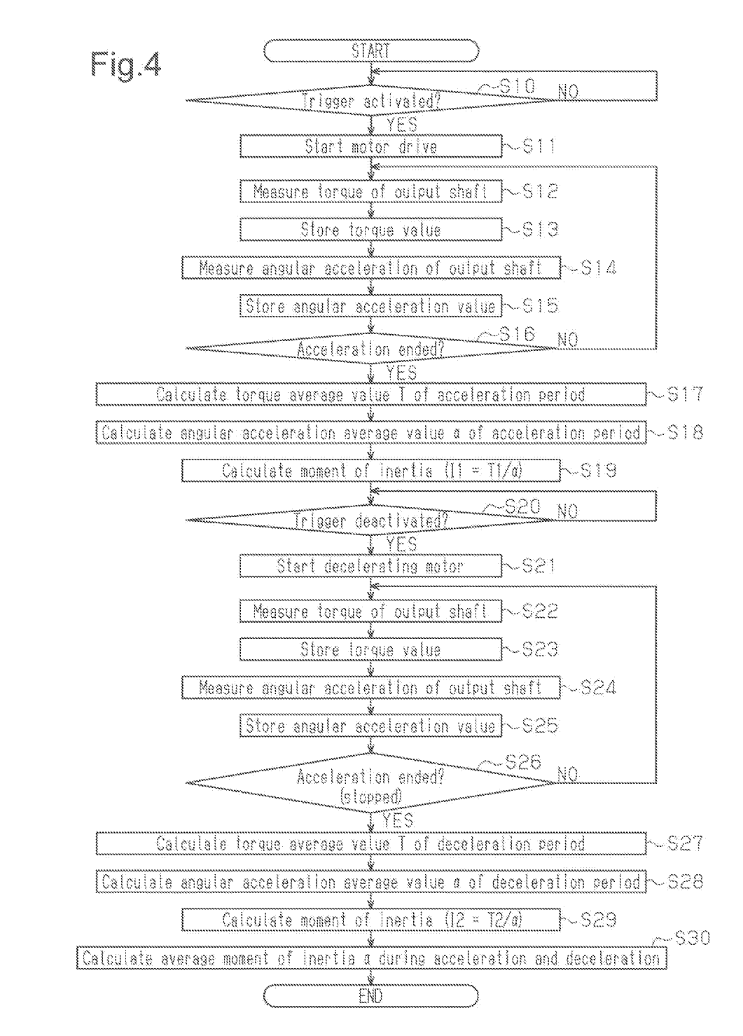

As shown in FIGS. 2 and 4, when the trigger lever 29 is operated to activate a trigger switch (not shown) (step S10: YES), the motor controller 54 of the controller 50 supplies drive current to the motor 15 to drive the motor 15 (step S11). This rotates the main shaft 21 and the bit 24.

The shaft torque of the main shaft 21, which serves as an output shaft, is calculated by the shaft torque sensor 26 and the shaft torque calculator 41 (step S12).

The shaft torque calculated in step S12 is stored in the buffer 47 (step S13).

The angular acceleration of the main shaft 21 is calculated by the angular acceleration sensor 27, the rotation angular calculator 42, and the angular acceleration calculator 43 (step S14).

The angular acceleration calculated in step S14 is stored in the buffer 48 (step S15).

The motor speed measurement unit 52 determines whether or not the motor 15 has stopped accelerating (step S16). When the measurement result of the motor speed measurement unit 52 shows that the motor 15 is continuing to accelerate (step S16: NO), the processing is repeated from step S12.

When the motor 15 stops accelerating (step S16: YES), the information of the shaft torque stored in the buffer 47 during the acceleration period is output to the moment of inertia calculator 44, and a torque average value T is calculated by the moment of inertia calculator 44 (step S17).

The information of the angular acceleration stored in the buffer 48 during the acceleration period is output to the moment of inertia calculator 44, and an angular acceleration average value α is calculated by the moment of inertia calculator 44 (step S18).

The moment of inertia calculator 44 calculates a moment of inertia I1 during the acceleration period from the torque average value T and the angular acceleration average value α (step S19). The moment of inertia I1 is calculated by dividing T1 by α. In steps S17 to S19, the angular acceleration and the shaft torque do not have to be calculated.

When the trigger lever 29 is released to deactivate the trigger switch (step S20: YES), the motor controller 54 of the controller 50 stops supplying drive current to the motor 15 and starts decelerating the motor 15 (step S21). This gradually decelerates the rotation speed of the main shaft 21 and the bit 24.

The shaft torque of the main shaft 21 is calculated by the shaft torque sensor 26 and the shaft torque calculator 41 (step S22).

The shaft torque calculated in step S22 is stored in the buffer 47 (step S23).

The angular acceleration of the main shaft 21 is calculated by the angular acceleration sensor 27, the rotation angular calculator 42, and the angular acceleration calculator 43 (step S24).

The angular acceleration calculated in step S24 is stored in the buffer 48 (step S25).

The motor speed measurement unit 52 determines whether or not the motor 15 has stopped decelerating, that is, whether or not the motor 15 has stopped (step S26). When the measurement result of the motor speed measurement unit 52 shows that the motor 15 is continuing to decelerate (step S26: NO), the processing is repeated from step S22.

When the motor 15 stops decelerating (step S26: YES), the information of the shaft torque stored in the buffer 47 during the deceleration period is output to the moment of inertia calculator 44, and the torque average value T is calculated by the moment of inertia calculator 44 (step S27).

The information of the angular acceleration stored in the buffer 48 during the deceleration period is output to the moment of inertia calculator 44, and the angular acceleration average value α is calculated by the moment of inertia calculator 44 (step S28).

The moment of inertia calculator 44 calculates a moment of inertia I2 during the acceleration period from the torque average value T and the angular acceleration average value α (step S29). The moment of inertia I2 is calculated by dividing T2 by α.

The moment of inertia calculator 44 calculates the average moment of inertia I during the acceleration and deceleration periods from the moment of inertias I1 and I2 calculated in steps S19 and S29 (step S30). The moment of inertia calculator 44 outputs the moment of inertia I to the moment of inertia holding unit 45 and stores the moment of inertia I in the moment of inertia holding unit 45. This allows the moment of inertia I for when the bit 24 is coupled to the main shaft 21 to be set so that the moment of inertia I is close to the moment of inertia when an actual task is performed.

The operation of the impact rotation tool 11 of the present embodiment will now be described.

For example, when tightening a bolt, a screw, or the like, the user operates the torque setting unit 51 to set the set torque in advance.

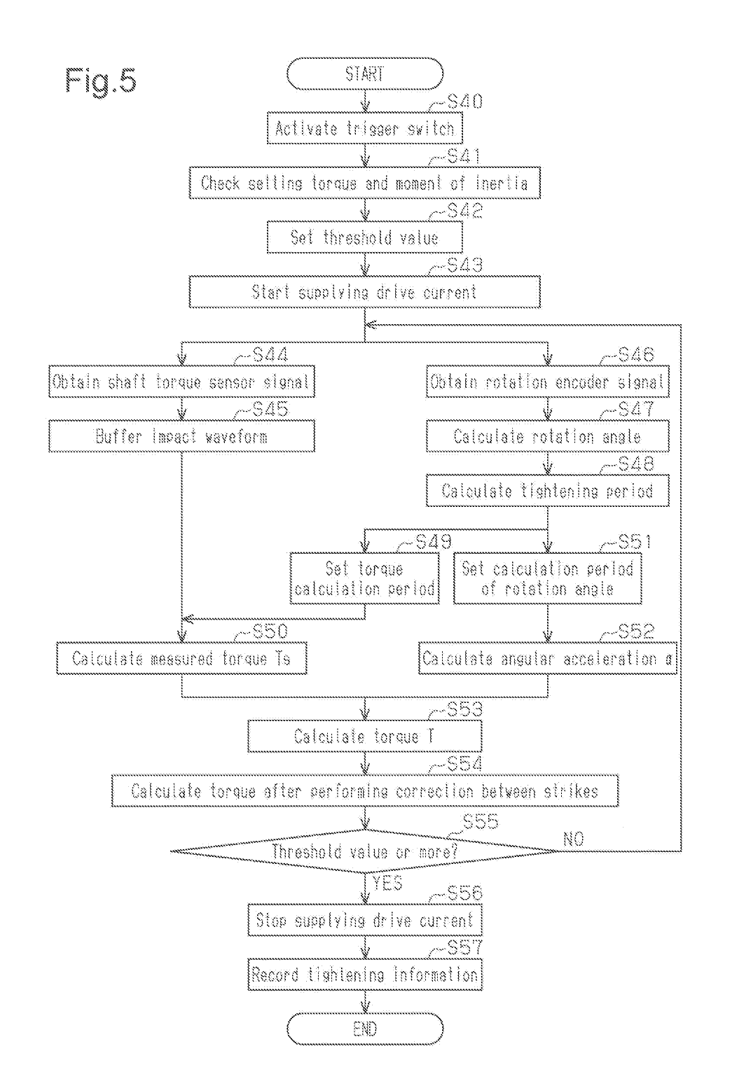

As shown in FIGS. 1, 2, and 5, when the trigger lever 29 is operated to activate the trigger switch (not shown) (step S40), the controller 50 checks the set torque set by the torque setting unit 51 and the moment of inertia stored by the moment of inertia holding unit 45 (step S41).

The stop determination unit 55 sets the target torque, which is a threshold value, based on the set torque that is set by the torque setting unit 51 (step S42). Then, the motor controller 54 of the controller 50 supplies drive current to the motor 15 to drive the motor 15 (step S43).

The shaft torque calculator 41 of the body control circuit 30 normally obtains the torque detection signal S1 detected by the shaft torque sensor 26 (step S44). The shaft torque calculator 41 provides the buffer 47, which is a temporary storage area, with the torque detection signal S1 (impact waveform) corresponding to a single strike so that the buffer 47 stores the torque detection signal S1 of each strike (step S45).

Further, the rotation angular calculator 42 of the body control circuit 30 obtains A-phase pulse signals Sa and B-phase pulse signals Sb (rotation encoder signals) detected by the angular acceleration sensor 27 (step S46). As shown in FIG. 6B, the pulse signals Sa and Sb each have the form of a square wave, and the phases of the pulse signals Sa and Sb are shifted by 90 degrees from each other.

The rotation angular calculator 42 calculates the rotation angle (step S47). One example of a change in the rotation angle will now be described. As shown in FIG. 6C, an impact increases the rotation angle. More specifically, when the anvil 20 is rotated and driven, rotation play is decreased between the anvil 20 and the bit 24 and then between the bit 24 and a fastener so that the fastener or the like is twisted to increase the rotation angle (section P1). Subsequently, the fastener is actually tightened to increase the rotation angle (section P2). After the fastener can no longer be tightened, the fastener or the like is untwisted and rotation play starts to form and decrease the rotation angle (section P3).

The angular acceleration calculator 43 calculates section P2, which is a tightening period in which tightening of the fastener actually starts (step S48). The angular acceleration calculator 43 calculates section P2 as a section corresponding to the difference of the maximum angle during the previous strike and the maximum angle during the current strike.

The torque calculator 46 sets a torque calculation period based on section P2, which is the tightening period calculated by the angular acceleration calculator 43 (step S49). In this example, the torque calculation period is set to section P2.

The torque calculator 46 calculates, as a measured torque Ts, the average value of torque values in the range of section P2 in the impact waveform (torque detection signal S1) of a single strike stored in the buffer 47 (step S50).

The angular acceleration calculator 43 sets the calculation period of the rotation angle based on section P2, which is a tightening period (step S51). In this example, the calculation period of the rotation angle is set to section P2.

The angular acceleration calculator 43 calculates the angular acceleration α from the data of the rotation angle θ in the range of section P2 (step S52). The method for calculating the angular acceleration α includes plotting a quadratic approximation curve in the range of section P2. The equation of the quadratic approximation curve is as follows.

θ=at²+bt+c [Equation 1]

The angular acceleration α is obtained by differentiating the angle θ twice. Thus, the angular acceleration α is calculated from the following equation.

$$α = \frac{{d}^{2} θ}{d {t}^{2}} = 2 a \qquad [ Equation 2 ]$$

The angular acceleration α may change in section P2, which is a tightening period. However, since the angular acceleration α is calculated easily, the angular acceleration α is obtained as a constant value to obtain the average value in section P2.

The angular acceleration α calculated by the angular acceleration calculator 43 is output to the torque calculator 46 through the buffer 48. The torque calculator 46 calculates the tightening torque T from the measured torque Ts of section P2 calculated by the torque calculator 46, the received angular acceleration α, and the moment of inertia I stored in the moment of inertia holding unit 45 (step S53). The tightening torque T is obtained from the following equation. In the following equation, A, B, and C are coefficients for adjustment (correction). If adjustment or the like is not required, A may be equal to 1, B may be equal to 1, and C may be equal to 0.

T=Ts×A−I×α×B+C [Equation 3]

The tightening torque T calculated for each strike may decrease without monotonically increasing. Thus, the torque calculator 46 takes this into account and calculates the tightening torque T (step S54). The torque calculator 46 calculates the tightening torque T from the moving average of data of, for example, two or three strikes. When the tightening torque calculation variation for each calculated strike is small and the tightening torque T monotonically increases, step S54 may be skipped to perform the following step.

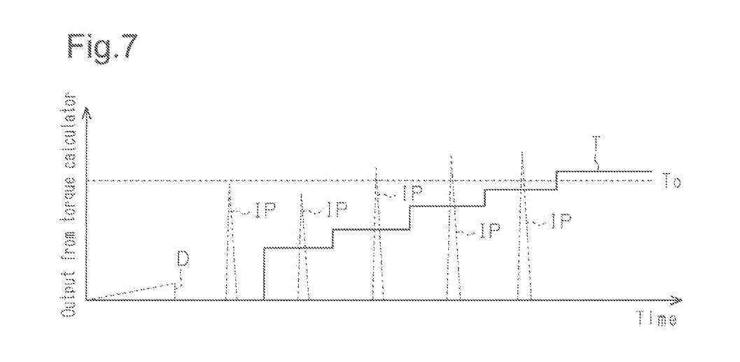

The change in the tightening torque T will now be described. As shown in FIG. 7, the hammer 19 does not strike the anvil 20 immediately after the impact rotation tool 11 starts to tighten a screw. Thus, the output of the shaft torque sensor 26 gradually increases as a fastener such as a screw or a bolt tightens (illustrated by D in FIG. 7). The hammer 19 strikes the anvil 20 when the torque exceeds a fixed value and repeatedly generates an impact pulse IP. Whenever the impact pulse IP is generated, the tightening torque T is updated by the calculated value. The calculated value is maintained until the next tightening torque T is calculated. Since it takes time to calculate the tightening torque T, the updating of the calculated value is delayed by a predetermined time from when the impact pulse IP is generated. The tightening torque T gradually increases as the fastener such as a screw or a bolt tightens. Thus, the calculated value of the tightening torque T calculated by the torque calculator 46 is updated in a stepwise manner whenever the impact pulse IP is generated.

When the calculated tightening torque T is less than the target torque To (step S55: NO), the stop determination unit 55 does not output a stop signal. Thus, the processing from steps S44 to S46 is repeated.

When the calculated tightening torque T is greater than or equal to the target torque To (step S55: YES), the stop determination unit 55 outputs a stop signal to instruct the motor controller 54 to stop the drive current to the motor 15. The motor controller 54 that has received the stop signal from the stop determination unit 55 stops the supply of the drive current to the motor 15 and stops driving the motor 15 (step S56). That is, when the torque calculated by the torque calculator 46 reaches the target torque To, the controller 50 stops driving the motor 15. As a result, when the tightening torque T reaches the target torque To, the driving of the impact rotation tool 11 stops.

Further, the stop determination unit 55 records the torque value, the time, and the like required for the tightening in the recorder 56 for each of the tasks performed by the user. This allows the user to obtain the torque value and the time for each task after completing the task.

The present embodiment has the advantages described below.

(1) The moment of inertia calculator 44 is capable of correctly measuring moment of inertia of an actual task by calculating the moment of inertia in a state in which the bit 24 is coupled to the main shaft 21. This increases the calculation accuracy of a tightening torque.

(2) The moment of inertia calculator 44 calculates the moment of inertia when the main shaft 21 serving as an output shaft accelerates and decelerates. This increases the calculation accuracy of the moment of inertia as compared to when calculating the moment of inertia during only acceleration or deceleration.

The above embodiment may be modified as described below.

In the above embodiment, the moment of inertia calculator 44 calculates the moment of inertia when the main shaft 21 serving as an output shaft accelerates and decelerates. Instead, for example, the moment of inertia calculator 44 may calculate the moment of inertia only when the main shaft 21 serving as an output shaft is accelerating or decelerating and use the moment of inertia for calculating the tightening torque.

In the above embodiment, the moment of inertia calculator 44 calculates the moment of inertia when the main shaft 21 serving as an output shaft accelerates once and decelerates. Instead, the main shaft 21 may accelerate or decelerate a number of times so that the moment of inertia calculator 44 calculates the moment of inertia from the shaft torque and the angular acceleration whenever the main shaft 21 accelerates or decelerates. Further, the main shaft 21 may accelerate and decelerate a number of times so that the moment of inertia calculator 44 calculates the moment of inertia from the shaft torque and the angular acceleration whenever the main shaft 21 accelerates or decelerates.

In the above embodiment, the moment of inertia is calculated when a fastener such as a bolt and a screw is not attached to the bit 24. However, the moment of inertia may be calculated when a fastener such as a bolt and a screw is attached to the bit 24. This allows for calculation of the moment of inertia that is closer to that of an actual task. In this case, the shaft torque and the angular acceleration may be measured from when a tightening task starts to when the fastener rests on a tightened subject to calculate the moment of inertia from the measured shaft torque and angular acceleration.

Although not described in the above embodiment, when the moment of inertia calculator 44 completes the calculation of the moment of inertia during the moment of inertia setting mode, a notification unit 49 may notify the user that the calculation of the moment of inertia is completed. The notification may be performed using a voice, a buzzer, or vibration.

In the above embodiment, the shaft torque may be measured (estimated) from, for example, the measured value of the current supplied to the motor 15. This allows the shaft torque sensor 26 to be omitted.

In the above embodiment, the angular acceleration of the main shaft 21 may be measured (estimated) from, for example, the speed of the motor 15. As described in the above embodiment, the rotation speed of the motor 15 can be measured based on a signal corresponding to the speed that is received from the speed detector 34. This allows the angular acceleration sensor 27 to be omitted.

The equation for calculating the angular acceleration α in the above embodiment is merely an example and may be modified.

In the above embodiment, a rotation encoder is used as the angular acceleration sensor 27 to detect an angle. Instead, an angular speed sensor (gyro sensor) may be used as the angular acceleration sensor 27. In this case, the angular acceleration is calculated by differentiating the angular speed detected by the gyro sensor with respect to time.

In the above embodiment, an acceleration sensor that enables detection of acceleration in the surface of the main shaft 21 in the circumferential direction may be used. In this case, the angular acceleration can be calculated by dividing the acceleration detected by the acceleration sensor by the radius.

The motor 15 may be an AC motor or a DC motor other than a brush motor or a brushless motor.

The drive source of the impact rotation tool 11 is not limited to a motor. Instead, for example, the drive source of the impact rotation tool 11 may be a solenoid. Alternatively, the drive source of the impact rotation tool 11 may be a hydraulic drive source instead of an electric drive source such as a motor or a solenoid.

The impact rotation tool 11 may be a non-rechargeable AC impact rotation tool or an air impact rotation tool.

A distortion gauge serving as a torque sensor may be adhered and coupled to the main shaft 21 to obtain data via a slip ring or through wireless communication.

In the above embodiment, the impact rotation tool is a portable handheld tool. However, the impact rotation tool is not limited in such a manner.

The above embodiment and each of the above modified examples may be combined.

1. A method for measuring moment of inertia of an impact rotation tool, the method comprising:
measuring a shaft torque applied to an output shaft driven by a drive source with a torque measurement unit;
measuring angular acceleration of the output shaft with an angular acceleration measurement unit; and
calculating, with a moment of inertia calculator, moment of inertia of a measured subject that is coupled to the output shaft when rotated by the output shaft based on the shaft torque measured by the torque measurement unit and the angular acceleration measured by the angular acceleration measurement unit.

2. An impact rotation tool comprising:
a drive source;
an impact force generator that changes power of the drive source into pulsed torque to generate impact force;
an output shaft that transmits the pulsed torque to a bit based on the impact force;
a torque measurement unit that measures a shaft torque applied to the output shaft;
an angular acceleration measurement unit that measures angular acceleration of the output shaft;
a moment of inertia calculator that calculates moment of inertia of the bit coupled to the output shaft when rotated by the output shaft based on the shaft torque measured by the torque measurement unit and the angular acceleration measured by the angular acceleration measurement unit;
a torque calculator that calculates tightening torque based on the angular acceleration, the shaft torque, and the moment of inertia; and
a controller that controls the drive source based on the tightening torque.

3. The impact rotation tool according to claim 2, wherein
the drive source is an electric motor, and
the torque measurement unit measures the shaft torque from a measured value of current supplied to the drive source.

4. The impact rotation tool according to claim 2, wherein
the drive source is an electric motor, and
the angular acceleration unit measures the angular acceleration of the output shaft from speed of the drive source.

5. The impact rotation tool according to claim 2, further comprising an operation unit that is operable to drive the drive source, wherein
the bit, which is a measured subject, is solely coupled to the output shaft, and
the moment of inertia calculator calculates the moment of inertia based on the shaft torque and the angular acceleration when a user operates the operation unit to rotate the output shaft.

6. The impact rotation tool according to claim 2, further comprising an operation unit that is operable to drive the drive source, wherein
the bit, which is a measured subject, is solely coupled to the output shaft, and
the moment of inertia calculator calculates the moment of inertia based on the shaft torque and the angular acceleration when a user operates the operation unit to rotate the output shaft and based on the shaft torque and the angular acceleration when the output shaft stops.

7. The impact rotation tool according to claim 2, further comprising an operation unit that is operable to drive the drive source, wherein
the bit, which is a measured subject, is solely coupled to the output shaft, and
the moment of inertia calculator calculates the moment of inertia based on the shaft torque and the angular acceleration when a user operates the operation unit to accelerate or decelerate the output shaft a number of times.

8. The impact rotation tool according to claim 2, further comprising an operation unit that is operable to drive the drive source, wherein
the bit, which is a measured subject, is solely coupled to the output shaft, and
the moment of inertia calculator calculates the moment of inertia based on the shaft torque and the angular acceleration when a user operates the operation unit to accelerate and decelerate the output shaft a number of times.

9. The impact rotation tool according to claim 2, wherein
the bit, to which a fastener is attached, is coupled to the output shaft,
the impact rotation tool is adapted to perform a task for tightening the fastener to a tightened subject, and
the moment of inertia calculator calculates the moment of inertia based on the shaft torque and the angular acceleration from when the task for tightening is started to when the fastener is mounted on the tightened subject.

10. The impact rotation tool according to claim 2, further comprising a notification unit that issues a notification of completion of calculation of the moment of inertia of the bit coupled to the output shaft.
